(19) United States
(12) Patent Application Publication
(10) Pub. No.: US 2016/0140622 A1
(43) Pub. Date: May 19, 2016

(54) USER SPECIFIC MERCHANT PAGE CUSTOMIZATION

(71) Applicant: Facebook, Inc., Menlo Park, CA (US)

(72) Inventors: Gen Wang, Seattle, WA (US); James Wah Hou Wong, Bellevue, WA (US); Jun Li, Sammamish, WA (US)

(21) Appl. No.: 14/546,625

(22) Filed: Nov. 18, 2014

(51) Int. Cl. G06Q 30/02; G06F 17/21; G06Q 50/00; G06F 17/30

(52) U.S. Cl. CPC G06Q 30/0269; G06F 17/30896; G06F 17/30905; G06F 17/212; G06Q 50/01

(57) ABSTRACT

One or more embodiments of the disclosure include methods and systems that allows for improved product presentation on a social networking page on a per user basis. For example, a social networking system can assist a merchant using a social networking system to provide a customized product viewing experience to each user of the social networking system that visits the merchant's social networking page. In some embodiments, the social networking system can provide the customized product viewing experience to each user based but determining and apply a product affinity score for each user.

### BACKGROUND

1. Technical Field

One or more embodiments relate generally to marketing through a social networking system. More specifically, one or more embodiments disclosed herein relate to systems and methods for allowing merchants to customize product presentation on a per user basis within a social networking system.

2. Background and Relevant Art

An increasing amount of commerce is originating from social networking activity. For example, social networking systems (such as, for example, the social networking systems provided by Facebook, Inc.™) are providing a valuable platform through which merchants can market their products (e.g., goods and services), as well as promote their physical (e.g., brick and mortar) and virtual (e.g., websites and mobile applications) retail sites. Social networking systems provide value to merchants in a number of ways. For example, social networking systems can facilitate a viral spread commerce activity among users, thereby increasing market presence of a product without direct action by a merchant providing the product. Furthermore, users of social networking systems provide user-specific information to the social networking system that can be used to provide highly-tailored advertisements and other marketing content to the users, thereby increasing purchase conversion percentages for merchants and increasing the effectiveness of marketing activities.

Despite the many advantages of using social networking systems for commerce, marketing products through social networking systems still suffers from one or more disadvantages. Primarily, social networking systems often display communications (e.g., social networking posts) on a merchant's social networking page in the order the communications were received by or posted to the social networking system. However, no regard is given to whether a communication corresponds to a product of the merchant. As a result, social networking systems may interlace product posts on the merchant's page with other non-product posts, such as pictures, updates, promotions, advertisements, etc. Accordingly, users visiting the merchant's social networking page must sift and sort through posts corresponding to updates and promotions when looking for products that the merchant offers. Causing a user to search for product posts from among other non-product posts can be frustrating to the user, can cause a user's interest in one or more products to fade, and can even cause the user to lose interest in purchasing products altogether from the merchant.

These and other disadvantages may exist with respect to commerce facilitated by way of a social networking system or service. Accordingly, there are a number of considerations to be made in improving merchant marketing of products over a social networking system.

### SUMMARY

One or more embodiments described below provide benefits and/or solve one or more of the foregoing or other problems in the art with methods and systems for product presentation within social networking systems. In particular, the methods and systems disclosed provide a customized product viewing experience to each user of a social networking system that visits a merchant's profile page (or simply “merchant page”) for the social networking system.

In some embodiments, a social networking system can customize a user's product viewing experience by providing a shopping portion on a merchant's social networking page. The shopping portion can include products that correspond to products found in social networking posts or other social networking communications from the merchant. For example, the social networking system can automatically identify product information from product posts that the merchant posts on the merchant's social networking page and can display the product information in the shopping portion of the merchant's social networking page. In addition, the social networking system can select which products to display to the user in the shopping portion of the merchant's social networking page. In this manner, users visiting the merchant's social networking page can easily browse through products the merchant offers in the shopping portion without needing to sift and sort through all of the posts on the merchant's social networking page for product posts.

In some embodiments, the social networking system can customize the shopping portion of a merchant's social networking page for each user that visits the merchant's social networking page. For example, the social networking system can display different products in the shopping portion of the merchant's social networking page for each user based on user and/or merchant preferences. For instance, each time a new user visits the merchant's social networking page, the social networking system can display products in the shopping portion that are likely of higher interest to the user (e.g., based on collected information regarding the user's interests and preferences) than products that are of lower interest to the user. Accordingly, the social networking system can provide a customized experience for each user browsing a merchant's products on the merchant's social networking page.

The one or more embodiments disclosed herein help improve a merchant's ability to market products on a merchant's social networking page without requiring additional support from a merchant. In particular, the social networking system automatically creates, customizes, and populates a shopping portion on a merchant's social networking page without any input from a merchant. In addition, the shopping portion on a merchant's social networking page provides a central product location for users to easily view multiple products offered by the merchant. Further, the embodiments disclosed herein improve a user's product browsing experience on a merchant's social networking page by displaying products that are of particular relevance to the user.

Additional features and advantages will be set forth in the description which follows, and in part will be obvious from the description, or may be learned by the practice of such exemplary embodiments. The features and advantages of such embodiments may be realized and obtained by means of the instruments and combinations particularly pointed out in the appended claims. These and other features will become more fully apparent from the following description and appended claims, or may be learned by the practice of such exemplary embodiments as set forth hereinafter.

### BRIEF DESCRIPTION OF THE DRAWINGS

In order to describe the manner in which the above-recited and other advantages and features of one or more embodiments can be obtained, a more particular description will be rendered by reference to specific embodiments thereof, which the accompanying drawings illustrate. It should be noted that the figures are not drawn to scale, and that elements of similar structure or function are generally represented by like reference numerals for illustrative purposes throughout the figures. These drawings depict only typical embodiments, and are not therefore considered to be limiting of its scope. Accordingly, various embodiments will be described and explained with additional specificity and detail using the accompanying drawings.

FIG. 1 illustrates a schematic diagram of a system in accordance with one or more embodiments described herein;

FIG. 2 illustrates a schematic diagram of one example implementation of the system of FIG. 1 in accordance with principles described herein;

FIG. 3 illustrates an example of a data table for use within a social networking system in accordance with one or more embodiments described herein;

FIG. 4 illustrates a graphical user interface including an example social networking page in accordance with principles described herein;

FIG. 5 illustrates another example graphical user interface including a product page in accordance with principles described herein;

FIG. 6 illustrates a graphical user interface including an example social networking storefront page in accordance with principles described herein;

FIG. 7 illustrates a graphical user interface including an example product addition form in accordance with principles described herein;

FIG. 8 illustrates an example of a product listing graphical user interface that includes a plurality of products in accordance with one or more embodiments described herein;

FIG. 9 illustrates a graphical user interface including a social networking merchant storefront page in accordance with principles described herein;

FIG. 10 illustrates a flowchart of an example method for customizing a merchant page for a user in accordance with an embodiment of the present invention;

FIG. 11 illustrates a flowchart of an example method for customizing a merchant page for a plurality of users in accordance with an embodiment of the present invention;

FIG. 12 illustrates a block diagram of a computing device in accordance with one or more embodiments described herein; and

FIG. 13 illustrates a network environment of a social networking system in accordance with one or more embodiments described herein.

### DETAILED DESCRIPTION

One or more of the embodiments disclosed herein provide improved processes and features for a merchant to market products on a social networking system. In particular, the methods and systems disclosed herein provide improved product marketing to users of a social networking system by displaying products in a shopping portion on a merchant's social networking page in an intelligent manner. Furthermore, one or more embodiments disclosed herein provide a customized product viewing experience by customizing products displayed in the shopping portion on a per-user basis.

In some embodiments, a social networking system can assist a merchant in marketing products on a merchant's social networking profile page (or “merchant page”). In particular, the social networking system can automatically obtain (e.g., extract and/or copy) product information included in social networking communications (e.g., social networking posts or other social networking communications) provided by the merchant. For example, the social networking system can analyze a social networking post to determine if the post includes information associated with a product (or “product information”), and then extract the included product information from the post. Thereafter, the social networking system can selectively and intelligently display the obtained product information within a “shopping portion” of the merchant's profile page designed to promote the merchant's products to users that visit the merchant page. In particular, for each user that visits the merchant page, the social networking system can select and display one or more products in the shopping portion based on information associated with the visiting user and information associated with the products available from the merchant. Accordingly, the social networking system can assist a merchant by providing a shopping portion within the merchant page that is dynamically customized for each user that visit's the merchant page. In addition, the social networking system can provide this customized shopping portion based on the merchant's previous social networking posts while requiring minimal or no additional actions by the merchant apart from providing the product posts. Further, by intelligently selecting and displaying multiple products in the customized shopping portion of the merchant page, users can easily view and/or buy products that are likely of interest to the user, without having to sift through multiple posts including non-product posts and product posts for products that are likely not of interest to the user.

As mentioned, in accordance with embodiments discussed herein, a social networking system can customize a shopping portion of a merchant page on a per-user basis. For example, the social networking system can customize the shopping portion for a user visiting the merchant page based on one or more characteristics of the user and/or one or more characteristics of the merchant's available products. The social networking system can customize the shopping portion in a number of ways. For example, in addition to selecting which and how many products to include in the shopping portion, the social networking system can customize an arrangement of the selected products, an order of the selected products, a display size of each selected product, a display position of each selected product, a prominence of each selected product, and/or any other aspect of how the products are selected and displayed to a user. In some embodiments, the social networking system can rank the merchant's products with specific respect to a user (e.g., based on the user's interests) and then customize the shopping portion based on the ranking of the products. For example, the social networking system can determine a product affinity score for each product and then rank the products according to their product affinity scores, as will be discussed in more detail below.

The features and processes disclosed herein enhance a merchant's ability to market products on a merchant's social networking page based on information from the merchant's normal course of social networking activities and without requiring additional action from the merchant. In particular, the social networking system automatically creates, customizes, and populates a shopping portion on the merchant page based on the merchant's social networking posts. In addition, the shopping portion on a merchant page provides a convenient location for users to easily view multiple products offered by the merchant. Further, the embodiments disclosed herein improve a user's product browsing experience by displaying products that are of particular relevance to the user.

As used herein, the term “merchant” may refer to any merchant of goods and/or services. The merchant may be affiliated with a social networking system (e.g., the merchant may have an account and profile page with the social networking system). Alternatively, the merchant may be a third-party merchant that is separate and independent of a social networking system. Examples of third-party merchants include, but are not limited to, merchants providing a specific category of product (e.g., DELL), merchants providing a broad variety of products (e.g., AMAZON), merchants having physical as well as virtual stores (e.g., SEARS), and merchants having only virtual stores (e.g., EBAY).

As used herein, the term “product” may refer to a good or service offered by a merchant. Products can include tangible goods, such as a device, vehicle, gadget, or clothing. Alternatively, products can be intangible, such as a service or policy. Further, products can include virtual goods and services. For example, a product can include digital data, such as a digital document, video, or audio file.

As used herein, the term “product information” may refer to any information or other content associated with a product. For example, product information can include text associated with a product (e.g., a title of the product, a description for the product, specifications for the product, a name of a manufacturer of the product, a unique identifier (or “product ID”) for the product, a price of the product, etc.), images associated with the product (e.g., digital photographs of various models or views of the product), video associated with the product (e.g., a video file including an advertisement for the product or a review of the product), audio associated with the product (e.g., an audio file including an advertisement for the product or a description of the product), and/or any other content or information associated with the product.

As used herein, the term “product affinity score” may refer to a score or other value that represents a user's interest in a product, or a connection strength between a user and a product. For example, a user's product affinity score for a product can represent a predicted level of the user's interest in the product. A user's product affinity score for a product can be calculated based on a variety of available information associated the user and/or the product, as will be explained in more detail below.

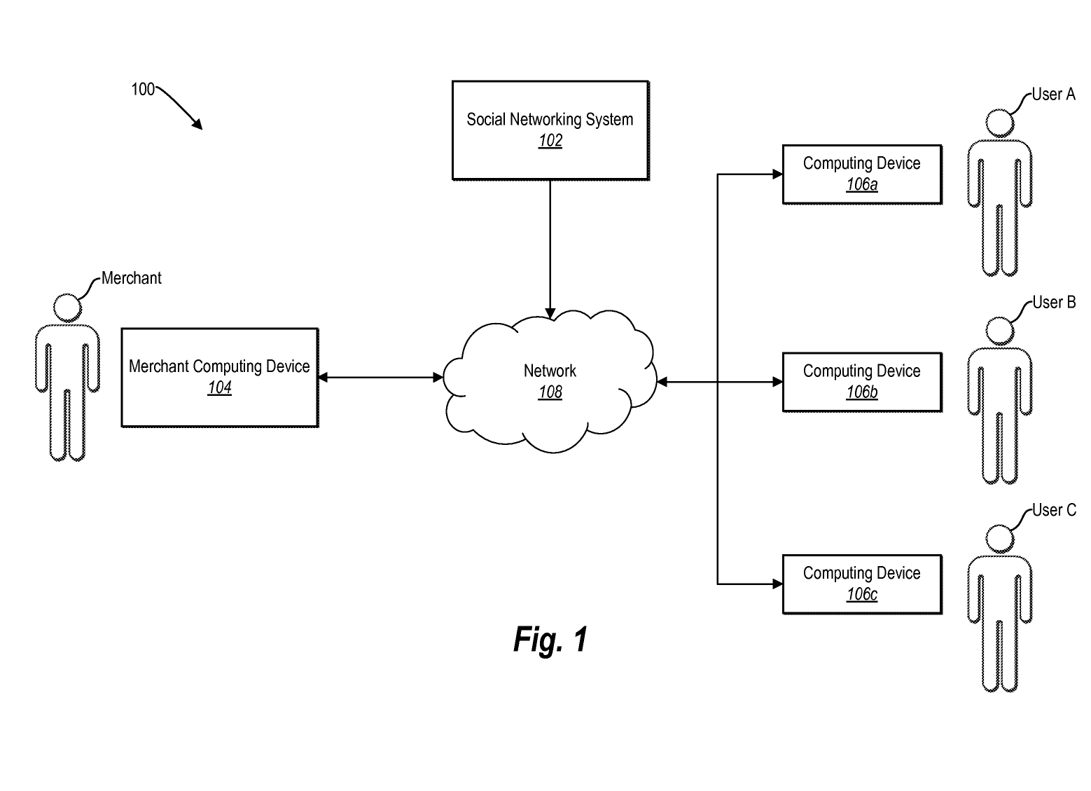

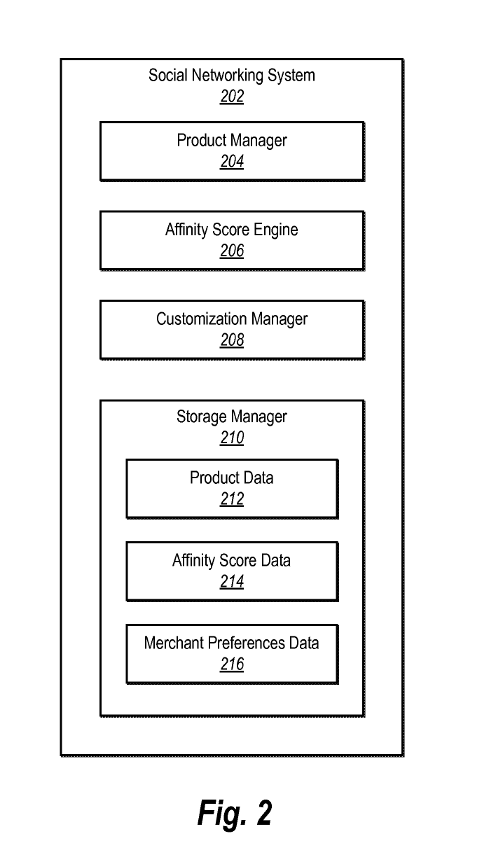

FIG. 1 is a schematic diagram illustrating a system 100 for improving product marketing for a merchant on a social networking system 102. An overview of the system 100 will be described in relation to FIG. 1. Thereafter, a more detailed description of the implementations, components, and processes of the system 100 will be described in relation to other figures, including FIGS. 2-9.

As illustrated by FIG. 1, the system 100 can include a social networking system 102, a merchant computing device 104, a merchant, computing devices 106 a-c, users, and a network 108. The merchant can communicate with the social networking system 102 via the merchant computing device 104. For example, the merchant can be an individual (i.e., human user) that interacts with the social networking system 102 using the merchant computing device 104. In a similar manner, Users A-C can communicate with the social networking system 102 via computing devices 106a-c, respectively.

The social networking system 102, merchant computing device 104, computing devices 106a-c, and the network 108 may be communicatively coupled, as illustrated in FIG. 1. The social networking system 102, merchant computing device 104, and computing devices 106a-c may communicate with each other using any suitable communication protocols. Although FIG. 1 illustrates a particular arrangement of components 102-108, various additional arrangements are possible. For example, the merchant device 104 may directly communicate with the social networking system 102, bypassing the network 108.

The social networking system 102 can generate, store, receive, and transmit social networking data, such electronic communications (e.g., social networking posts) or messages sent by the merchant. For example, the social networking system 102 can receive an electronic communication from the merchant computing device 104 in the form of a social networking post. The social networking post can be product related (e.g., a product post) or non-product related.

Upon receiving the social networking post, the social networking system 102 can add the social networking post to a merchant page. The social networking system 102 can provide the merchant page to computing devices (e.g., computing devices 106a-c) used by one or more users of the social networking system 102 (e.g., Users A, B, and C) by way of a web or mobile application. In addition, the social networking system 102 can provide merchant related social networking pages (e.g., a storefront page, a product information page, etc.) to users of the social networking system 102 as described below in additional detail.

The merchant, using the merchant computing device 104, can modify, manage, and add one or more products that the merchant offers to users by way of the social networking system. For example, the merchant can add additional products to promote by way of a merchant page. The merchant can also modify product information, such as the product title, description, price, image of the product, inventory, etc. Further, the merchant can promote or demote products that the merchant is marketing to users that visit the merchant page.

The computing devices 106a-c can facilitate user access to the social networking system 102. For example, user A can use computing device 106a to view a merchant page on the social networking system 102. In a similar manner, user C can use computing device 106c to view the same merchant page on the social networking system 102. Further, each user, via a computing device 106, can access and interact with various pages corresponding to the merchant, such as a merchant page, a storefront page, and one or more product pages, as will be explained in more detail below.

In one or more embodiments, and as will be described below, the social networking system 102 can customize a merchant page on a per-user basis. In other words, even if User A and User C view the same merchant page on the social networking system 102, the social networking system 102 can provide a customized user experience such that User A and User C each view a different version of the merchant page because the merchant page is individually tailored for each user. For example, the social networking system 102 can customize the merchant page for each user based on the product interests of each user. In particular, the social networking system 102 can customize the merchant page based on one or more affinity scores associated with a user.

FIG. 2 illustrates a schematic diagram illustrating a social networking system 202 in accordance with one or more embodiments disclosed herein. The social networking system 202 illustrates one example embodiment of social networking system 102. In particular, FIG. 2 illustrates a social networking system 202 and various social networking system components 204-210.

Each of the components 204-210 of the system 202 may be in communication with one another using any suitable communication technologies. It will be recognized that although components 204-210 are shown to be separate in FIG. 2, any of components 204-210 may be combined into fewer components, such as into a single component, or divided into more components as may serve a particular embodiment.

The components 204-210 can comprise software, hardware, or both. For example, the components 204-210 can comprise one or more instructions stored on a computer-readable storage medium and executable by one or more processors of one or more computing devices. When executed by the one or more processors, the computer-executable instructions can cause one or more computing device(s) to perform the methods described herein. Alternatively, the components 204-210 can comprise hardware, such as a special purpose processing device to perform a certain function or group of functions. Additionally or alternatively, the components 204-210 can comprise a combination of computer-executable instructions and hardware.

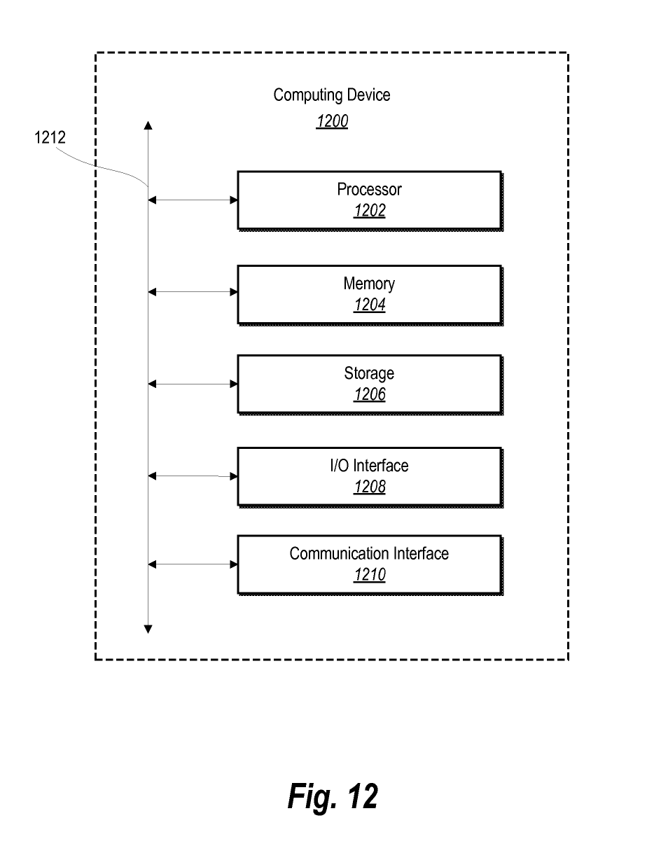

In some embodiments, one or more computing devices can implement the social networking system 202. For example, one or more computing devices described below in connection with FIG. 12 can implement the system 202. In particular, a server device may perform one or more operations associated with customizing a merchant page on a per-user basis, as disclosed herein.

As shown, the social networking system 202 can include, but is not limited to, a product manager 204, an affinity score engine 206, a customization manager 208, and a storage manager 210 storing product data 212, affinity score data 214, and merchant preferences data 216. In general, the product manager 204 can manage products made available by a merchant by way of the social networking system 202. The affinity score engine 206 can determine a product affinity score for a product for each user of the social networking system 202. The customization manager 208 can customize a merchant page for a user based on product affinity scores corresponding to the user. The storage manager 210 can store and retrieve data, such as product data 212, affinity score data 214, and merchant preferences data 216.

As mentioned, the social networking system 202 can include a product manager 204. In one or more embodiments, the product manager 204 can manage products for a merchant. For example, the product manager 204 can facilitate the promotion the merchant's products by way of a merchant page (i.e., a profile page for the merchant). In addition, as described in more detail below, the product manager 204 can identify product posts on a merchant page, extract information related to products from the product posts, and store/retrieve product data 212 from the storage manager 210. The product manager 204 can also facilitate the addition, removal, and modifications of products by a merchant.

In some embodiments, the product manager 204 can identify products within posts on a merchant page (e.g., social networking posts made by a merchant, and viewable by way of the merchant page). For example, the product manager 204 can identify whether a post is a product post or a non-product post. In general, a product post features and/or describes one or more products while a non-product post is not specific to a particular product or products. For example, a non-product post can be directed towards general updates, advertisements, sales, promotions, pictures, contest, notices, and/or comments associated with the merchant. A product post may include product content (e.g., content or information that is related to a particular product or products, such as a product title, a product identification number (or “product ID”), product media (e.g., images or videos), or a link to a web page associated with the product), as well as non-product content (e.g., content that is not specific to a particular product). Once the product manager 204 has determined that a post is a product post, the product manager 204 can identify product content within a post.

In one or more embodiments, the product manager 204 can extract product content from a product post. For example, the product manager 204 can extract product information—such as a product name, a product price, a product description, a product ID, and/or a link to a product page (e.g., a third-party web page for the product or a social networking page for the product available by way of the social networking system 202)—and product content—such as product videos and images. In some embodiments, the product manager 204 can use an extracted product ID or link to a product page to obtain additional information about a product. For example, the product manager 204 can utilize the product ID to identify a product feed associated with the product or can use the link to visit and obtain information from the linked product page.

In some embodiments, the product manager 204 can store product information using the storage manager 210. For example, after the product manager 204 extracts product information for a product, the product manager 204 can store the product information as product data 212 using the storage manager 210. Additionally or alternatively, the product manager 204 can store product information in another locating, such as in a remote database. Further, the product manager 204 can retrieve product data 212 from the storage manager 210. For example, the product manager 204 can retrieve product data 212 from the storage manager 212 for a particular product in response to a request for product information corresponding to the particular product. In addition, the product manager 204 can use an identifier, such as the product name or product ID when retrieving product data 212 from the storage manager 210 for a product. For instance, the product manager 204 can provide the storage manager 210 a product ID and the storage manger 210 can return corresponding product data 212.

In some embodiments, the product manager 204 can facilitate the addition, removal, and/or modifications of products made available by way of a merchant page. For example, a product manager 204 can assist a merchant in creating a product post, and product manager 204 can then obtain product content based on the created product post. Alternatively, in some embodiments, the product manager 204 can assist the merchant in adding product one or more products to the merchant page independent of a product post. For example, the product manager 204 can provide one or more graphical user interfaces including options and/or fields through which the merchant can provide product information for one or more products the merchant would like to promote through the merchant's profile page, as will be described in more detail below.

In some embodiments, product manager 204 can create, delete, and/or modify one or more product nodes representative of one or more products. For example, product manager 204 can create a product node based on a product post from a merchant. In particular, product manager 204 can obtain product content from the product post and store the product content within a product node created to represent the product. Product manager 204 can further create an edge between the product node and a node representing the merchant, thereby reflecting that the product is available from the merchant. Product manager 204 can then add content to, delete content from, and/or modify the content stored within the product node based on additional information received from the merchant. A more detailed description of nodes and edges within a social graph is provided below.

As illustrated in FIG. 2, and as mentioned above, the social networking system 202 can also include an affinity score engine 206. The affinity score engine 206 can be configured to determine a product affinity score on a per-user basis. As mentioned above, an affinity score between a user and a product may represent an expected level of interest by the user in the product. The affinity score engine 206 can determine a set of product affinity scores for a user by determining a product affinity score for each product made available by a merchant. Furthermore, the affinity score engine 206 can determine a set of product affinity scores for each user that visits a merchant page. For example, affinity score engine 206 can determine a first set of product affinity scores for a first user (e.g., User A) and a second set of product affinity scores for a second user (e.g., User B) that differs relative to the first set of product affinity scores.

The affinity score engine 206 can determine a product affinity score based on one or more product affinity factors. For example, the affinity score engine 206 can determine a product affinity score based on one or more of the following: user profile information, user activity, social trends, merchant input, any other suitable factors, or a combination thereof. While a number of example product affinity factors are described herein, one will appreciate that additional product affinity factors can be used in determining a product affinity score for a user.

As mentioned, the affinity score engine 206 can determine a product affinity score, or a set of product affinity scores, based on user profile information. User profile information can include an age, a gender, a name, a marital status, a health status, a number of children, an employment status, an employment pattern, preferences (e.g., product preferences), likes, dislikes, and/or attitudes of a user. User profile information can additionally or alternatively include where a user lives, wherein a user works, wherein a user frequently visits, and wherein a user travels. In addition, user profile information can include an economic situation (e.g., income level and/or financial standing), a socioeconomic status, an education level, and/or other demographic information.

The affinity score engine 206 can utilize user profile information associated with a user to determine product affinity scores for products available through a merchant. For example, the affinity score engine 206 can use the user's age and/or gender to determine which products from a merchant are most gender and age appropriate for the user, and calculate corresponding product affinity scores accordingly. As another example, the affinity score engine 206 can use a user's income level to determine if a user is in a position to purchase a particular product, and adjust a product affinity score for the particular product accordingly. As a further example, the affinity score engine 206 can use a user's product preferences to identify products that the user is likely to prefer or not prefer based on the user product preferences, and adjust corresponding product affinity scores accordingly. In some embodiments, the affinity score engine 206 can calculate a product affinity score based on a correlation of one or more product characteristics, product features, and/or pieces of product information to user profile information associated with a user. In particular, the affinity score engine 206 can identify one or more product characteristics and then determine whether user profile information correlates in any way to the product characteristics. To illustrate, one or more characteristics of a product may indicate that the product is meant for use by children of a particular age. The affinity score engine 206 may then analyze user profile information for a user to determine if the user has children of the particular age. If the user has children of the particular age, the affinity score engine 206 may assign a higher affinity score to the product for the user than if the user does not have children of the particular age. As another illustration, one or more characteristics of a product may indicate that the product is meant for use in cold climates. The affinity score engine 206 can analyze user profile information for a user to determine whether the user lives in a cold climate or frequently travels to cold climates. If the user lives in a cold climate, the affinity score engine 206 may assign a higher affinity score to the product for the user than if the user does not live in a cold climate and/or only visits cold climates occasionally. As an example, if the affinity score engine 206 is determining affinity scores for snow skis, the affinity score engine 206 may assign a higher affinity score to a user living in Utah than to a user living in Florida. The affinity score engine 206 may assign an affinity score for snow skis.

The affinity score engine 206 can determine a product affinity score based on additional factors and corresponding information. For example, as mentioned above, the affinity score engine 206 can determine a product affinity score based on user activities. User activity can include a user's browsing history (e.g. products browsing history, non-product browsing history, user searches, website history, etc.), shopping activity (e.g., product purchases, additions of products to shopping carts, product views, visits to brick-and-mortar merchant locations, etc.), social networking activity (e.g., “likes,” shares, comments, posts, messages between social networking users, social networking “check-ins,” social networking connections between users, social networking group membership, product ratings, product recommendations, or any other type of interactions with a social networking system), tracked activity (e.g., as evidenced by cookies, session variables, and/or other tracking tools), and/or any other activity associated with a user. The affinity score engine 206 can further determine whether activity data for a user is related to a particular product or product category, and then determine one or more product affinity scores accordingly. For example, based on a user's social networking activity, the affinity score engine 206 may determine that the user has provided one or more posts associated with a product, has “liked” content related to the product, and/or has visited one or more social networking profile pages associated with the product. As a result, the affinity score engine 206 may assign a higher product affinity score to the user than to a user whose social networking activity is not related to the product in any way. As a further example, the affinity score engine 206 may determine, based on a user's shopping activity, that a user frequently purchases or shops for products within a particular product category. As a result, the affinity score engine 206 may assign a higher product affinity score to the user for products in the particular product category and assign a lower product affinity score to another user that does not frequently purchase or shop for products in the particular product category.

In addition, the affinity score engine 206 can determine a product affinity score or a set of product affinity scores based on social trends. Social trends can include overall popularity, rating, and/or ranking of a product. For example, the affinity score engine 206 can factor in the percentage of users that would recommend a product to a friend in determining the product affinity score for the product. Further, social trends can include sales volume, sales rate, and sales history of a product. For instance, the affinity score engine 206 can factor in whether a product is a “trending,” top-selling, or “hot” item when determining a product affinity score. If, based on the social trends, the affinity score engine 206 determines that a particular product is currently popular (e.g., based on recent sales rates and/or social networking activity related to the particular product), the affinity score engine 206 may assign a higher product affinity score to the particular product and assign a lower product affinity score to another product that is not currently popular.

Social trends can also include activity of a user's social networking connections (i.e., “friends”). In particular, social trends can indicate what friends of the user have bought the product, recommended the product, provided feedback (e.g., positive or negative) for the product, discussed the product, and/or shared content related to the product). For example, products associated with a large number of “likes” by friends of a user can be given a more favorable product affinity score than products associated with a lower number of “likes.” As another example, the affinity score engine 206 can discount the product affinity score for a product when friends of the user have given poor or unfavorable ratings for the product.

Further, the affinity score engine 206 can determine a product affinity score based on merchant input. Merchant input can include product inventory, sale information, profit margin, product age, favorable products, and/or merchant preferences. For example, a merchant may prefer to promote or feature a particular product. Accordingly, in response to a request from the merchant to promote a particular product, the affinity score engine 206 can increase the product affinity score for the particular product. As another example, the affinity score engine 206 can increase the product affinity scores for products that are on sale or part of a current or future promotion. As described below, a merchant can promote or demote products, which can affect the affinity score engine's 206 determination of the product affinity score for the product.

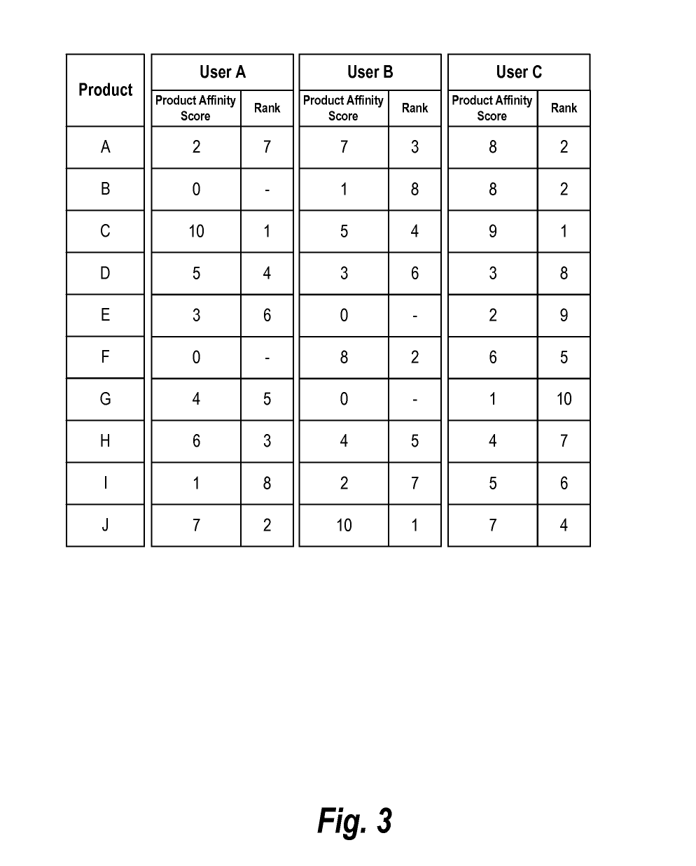

Using one or more of the product affinity factors describe above, or other product affinity factors, the affinity score engine 206 can determine (e.g., calculate) a product affinity score or a set of product affinity scores for a user. In particular, the affinity score engine 206 can determine a set of product affinity scores for each user that visits the merchant page. Further, the affinity score engine 206 can store product affinity scores as affinity score data 214 via the storage manager 214. An illustrative example of determining a set of product affinity scores is provided below in connection with FIG. 3.

In addition, as one will appreciate, the affinity score engine 206 can apply different weighting to product affinity factors when determining a product affinity score for each user. For example, the affinity score engine 206 can weight previous interactions more heavily than social trends. As another example, the affinity score engine 206 can apply the greatest weight to merchant input. The affinity score engine 206 can also employ a number of other weighting techniques. As yet another example, the affinity score engine 206 can increase the weight associated with merchant input when the merchant pays the social networking system 202 to have merchant inputs given greater influence when the affinity score engine 206 determines product affinity scores.

As mention above, and as illustrated in FIG. 2, the social networking system 202 can include a customization manager 208. The customization manager 208 can customize a merchant page on a per user basis. For example, the customization manager 208 can create and populate a shopping portion on the merchant page based on information specific to a visiting user. In addition, the customization manager 208 can customize a user-specific storefront page that displays products offered by the merchant.

In one or more embodiments, the customization manager 208 can customize the merchant page for a user using product affinity scores. For example, the customization manager 208 can use product affinity scores to determine how to display products. To illustrate, the customization manager 208 can receive a set of product affinity scores from the affinity score engine 206 and/or from the storage manager 210. Using the product affinity scores, the customization manager 208 can rank corresponding products. For instance, for a particular user, the customization manager 208 can rank products having a favorable product affinity score above products having an unfavorable product affinity score. By ranking products for a particular user, the customization manager 208 can prioritize products according to the user's potential interest in each product when customizing the merchant page.

As an example, the customization manager 208 can use the product affinity scores and/or product rank to identify which products to display to a user. For instance, the number of products displayed in the shopping portion may be limited by the size of the shopping portion on the merchant page. Accordingly, the customization manager 208 can use the product ranking to identify which products to display in the shopping portion for the user. Further, if the shopping portion size changes, the customization manager 208 can use the product rankings to determine which products should be added or removed based on the new shopping portion size.

Alternatively, in some embodiments, the customization manager 208 can provide navigational ability when the customization manager 208 identifies more products to be displayed than can be displayed in the shopping portion at one time. For example, the customization manager 208 can determine to display each product that has an affinity score above a threshold value. Thus, when the number of products is greater than that number of products that can be displayed in the shopping portion, the customization manager 208 can add user navigation controls to the shopping portion. For example, the customization manager 208 can add a scroll bar to the shopping window to allow a user to scroll through products displayed in the shopping portion when more products are included in the shopping portion than are displayable at one time.

In additional or alternative embodiments, the customization manager 208 can dynamically set the size of the shopping portion. For example, when the user has a large number of products for which the user has a high product affinity score, the customization manager 208 can determine to increase the shopping portion on the merchant page. For instance, the customization manager 208 can increase the size of the shopping window in a vertical and/or horizontal direction. Increasing the size of the shopping portion can allow the customization manager 208 to display additional products to the user on the merchant page.

The customization manager 208 can also determine the size and position of each product that the customization manager 208 displays in the shopping portion. For example, the customization manager 208 can display one product more prominently than other products within the shopping portion of the merchant page. For instance, the customization manager 208 can visually distinguish one product with respect to one or more other products. To illustrate, the customization manager 208 may display one product twice as big as another product. In some instances, the customization manager 208 can display a particular product more prominently when the product affinity score for the particular product is more favorable than the product affinity scores for other products displayed in the shopping portion. In some examples, the customization manager 208 can use the difference in product affinity scores to determine how prominently to display a particular product. In particular, the prominence of one product over another product may be based on a ratio of one product affinity score relative to another.

In some embodiments, the customization manager 208 can change which products it displays to a user in the shopping portion while the user is viewing a merchant page. For example, the customization manager 208 can rotate which products are displayed to a user. For instance, the customization manager 208 can rotate products displayed within the shopping portion according to a timer and/or user action. Further, the customization manager 208 can dynamically change the display of products within the shopping portion as product affinity scores change. For example, based on user interactions, updated social information, and/or merchant changes, the affinity score engine 206 can send updated product affinity scores to the customization manager 208, and the customization manager 208 can change the display of products within the shopping portion based on the updated product affinity scores.

As shown in FIG. 2, the social networking system 202 can include a storage manager 210. As mentioned above, the storage manager 210 can include product data 212 representative of product information, affinity score data 214 representative of one or more product affinity scores, and merchant preferences data 218 representative of one or more merchant preferences. In additional or alternative embodiments, storage manager 210 can store any other types of data necessary or beneficial for providing the features disclosed herein.

Reference is now made to FIG. 3, which illustrates an example data table that shows ranked sets of product affinity scores for User A, User B, and User C. For instance, the set of product affinity scores for User A, User B, and User C can correspond to Products A-J.

The product manager 204 can identify Products A-J based on corresponding social networking posts from a merchant. For example, the product manager 204 can extract product information for Products A-J from various product posts and the storage manager 210 can store the extracted product information as product data 212. Additionally or alternatively, the product manager 204 can send the extracted product information to the affinity score engine 206.

For each user, the affinity score engine 206 can determine a product affinity score for each of Products A-J based on information associated with the corresponding user and information associated with the corresponding product. For example, the affinity score engine 206 can determine User's A product affinity score for each of product. For instance, the affinity score engine 206 can determine for User A, that Product A has a product affinity score of two (2), Product B has a product affinity score of zero (0), Product C has a product affinity score of ten (10), and so on, as shown. Similarly, the affinity score engine 206 can determine, for User B, that Product A has a product affinity score of seven (7), Product B has a product affinity score of one (1), Product C has a product affinity score of five (5), and so on, as shown.

As described above, the affinity score engine 206 can determine a product affinity score based on one or more product affinity factors. Further, as shown in FIG. 3, the affinity score engine 206 can determine different product affinity scores for each user. To illustrate by way of example, Products E and G may be women's skirts. User B may be male and User C may be female. Further, User B may have never purchased women's skirts, while User C has previously purchased women's skirts. Accordingly, the affinity score engine 206 can determine, based at least in part on the above factors, a favorable product affinity score for Product E and G (e.g., nine (9) and ten (10)) for User C and a dis-favorable score for Product E and G (e.g., zero (0) and zero (0)) for User B.

As described above, the customization manager 208 can customize a display of products on a merchant page based on a ranking of the products based on their product affinity scores. For example, for User C, the customization manager 208 can rank Product C as the highest ranked product (e.g., rank 1) based on Product C having the highest product affinity score for User C, and can rank Product G as the lowest ranked product (e.g., rank 10) based on Product G having the lowest product affinity score. Further, in some instances, the customization manager 208 can assign the same rank to two products that share the same product affinity score, such as Products A and B for User C.

The customization manager 208 can use the rankings to customize the merchant page. For example, the customization manager 208 can use the rankings to identify which products to display in a shopping portion of the merchant page for a user. For instance, if the shopping window can only include of four (4) products. The customization manager 208 can use the rank to identify the top four (4) ranked products. For example, the customization manager 208 can identify Products, J, F, A, and C to display for User B.

In addition, the customization manager 208 can use the rank to determine the order, size, and/or position of products displayed within the shopping portion. For example, the customization manager 208 can order the selected products within the shopping portion according to rank of the selected products. As another example, the customization manager 208 can display one product larger than another product based on the ranking of the two products and/or the relative differences in the corresponding product affinity scores. To illustrate, the customization manager 208 can display Product C with a size significantly larger than other products displayed for User A because the product affinity score for Product C is a significantly higher than the product affinity scores for other products. One will appreciate that the product affinity scores illustrated in FIG. 3 are merely illustrative and that other types and/or ranges of values can be employed. Further, the product affinity scores in FIG. 3 may correspond to a linear, logarithmic, exponential, normalized, or other type of scale.

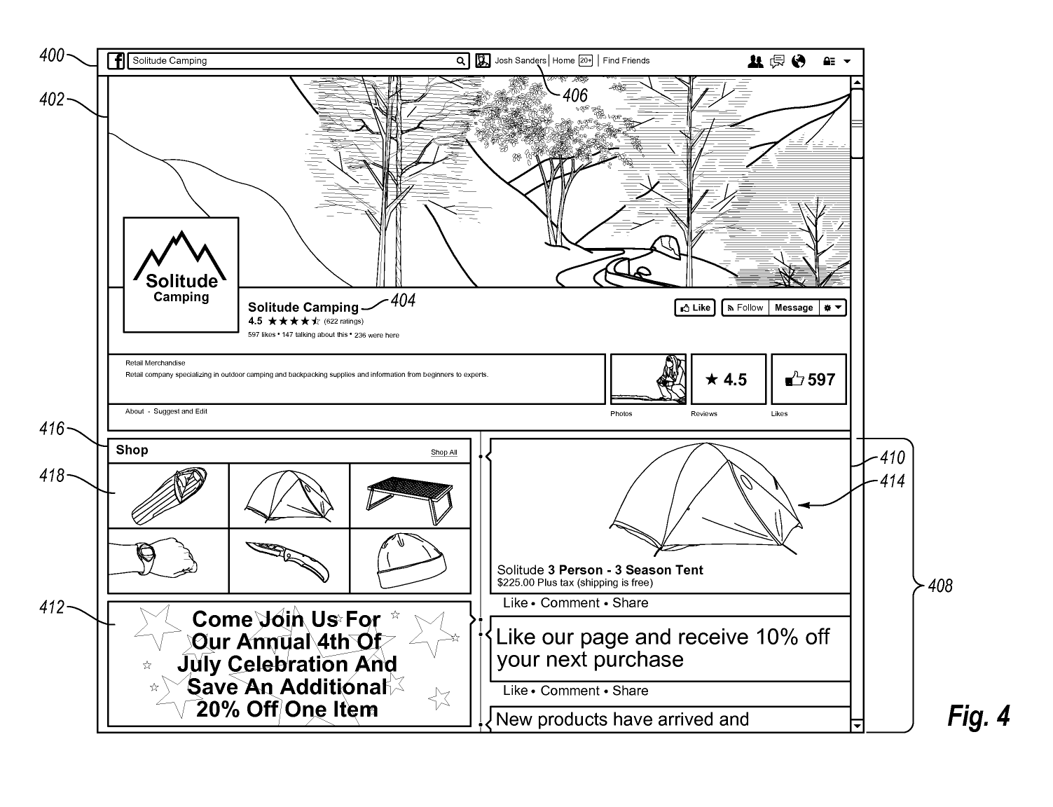

FIG. 4 illustrates a graphical user interface including an example graphical user interface for a merchant social networking page 400 (or “merchant page 400”). The merchant page 400 includes a variety of information, content, and options associated with one or more social networking features. As shown, the merchant page 400 includes a header portion 402 for a merchant 404, as viewed by a user 406. The header portion 402 can include general information and options associated with the merchant 404. The merchant page 400 also includes a news feed 408 including a plurality of communications (e.g., posts) associated with the merchant 404. As shown, the news feed 408 can include product posts, such as product post 410, and non-product posts, such as non-product post 412. As described above, a product post 410 can provide product information associated with a product 414, such as the “3 Person—3 Season Tent” made by “Solitude” for “$225.00 Plus tax.” In general, product posts 410 can include a variety of product information and a plurality of options associated with product 414. For example, the product post 410 can include information regarding a provider/manufacturer of product 414, a name of product 414, a description of product 414, an image of product 414, etc. In addition, the product post 410 can include a plurality of options including an option to “like” product 414 and/or “like” the product post 410, an option to purchase product 414, an option to save product 414 to a wish list, an option to visit a third-party website (e.g., an ecommerce website) associated with product 414 or merchant 404, an option to share the product post 410, an option to comment on the product post 410, and/or any other suitable options associated with product 414 or product post 410.

Non-product posts 412 can include a variety of general information and a plurality of options associated with the merchant 404, but that is not specific to any particular product. For example, the non-product post 412 can include information regarding events, sales, promotions, merchant updates, etc. Similar to product post 410, non-product post 412 can include a plurality of options including an option to “like” the non-product post 412, an option to share the non-product post 412, and an option to comment on the non-product post 412.

As further shown in FIG. 4, the merchant page 400 can include a shopping portion 416 (e.g., an area or box devoted to shopping for products offered by the merchant 404) included in the news feed 408. In some embodiments, the shopping portion 416 can span the merchant page horizontally, for example, above and/or next to the news feed 408. Additionally or alternatively, the shopping portion 416 can be taller, wider, and/or have any other shape or size within the merchant page 400.

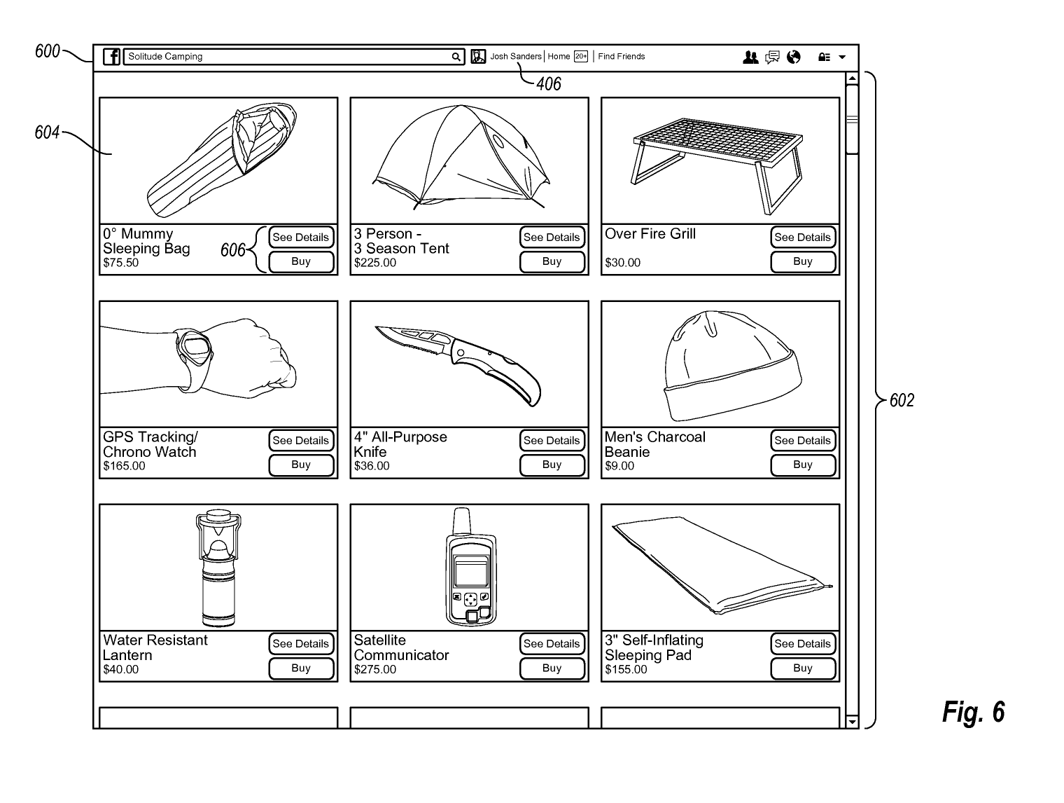

The shopping portion 416 can include a variety of items. For instance, the shopping portion 416 can include one or more product items, such as product 418. In addition, the shopping portion 416 can contain one or more links (e.g., “Shop” or “See All”) to display additional product items 418 not displayed in the shopping portion 416. For example, when the user 406 selects the “See All” link, the user 406 is redirected to a customized storefront page, described below in connection with FIG. 6.

The shopping portion 416 can include product items corresponding to product posts found in the news feed 408. In particular, the shopping portion 416 can include a selection of products identified (e.g., by customization manager 208) as being particularly relevant to user 406. Displaying product item 418 within the shopping portion 416 can include displaying an image, a name, a description, and/or any other product information for the product item. For example, one of the products in the shopping portion comprises an image corresponding to the product 414 found in product post 410 (e.g., an image for the “3-Person—3 Season Tent,” shown in product post 410).

As described above, the social networking system 202 can customize products within the shopping portion 416. For example, the social networking system 202 can identify, based on corresponding product affinity scores, which products are most relevant for a user and display product information corresponding to those products within the shopping portion 416. In addition, the social networking system 202 can order the products within the shopping portion 416 according to a ranking and/or scoring of the products. Further, the social networking system 202 can dynamically change which products are included in the shopping portion 416 and/or the order of the products included in the shopping portion 416.

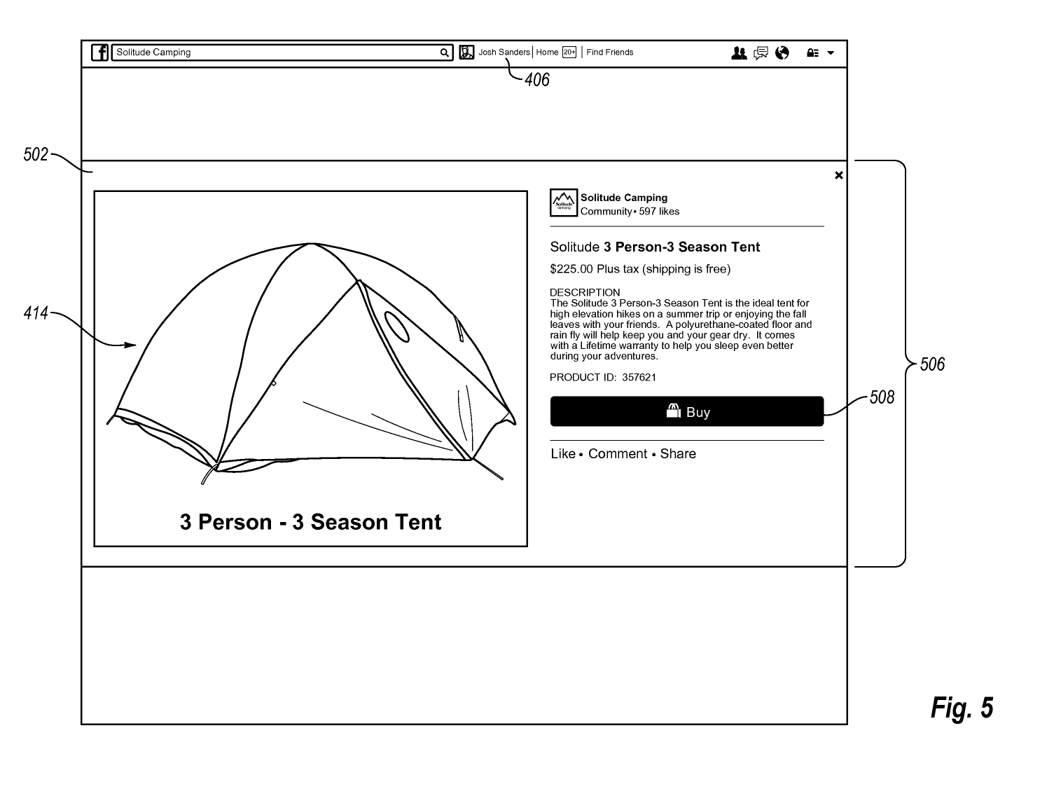

A user 406 can interact with a product within the shopping portion 416 to obtain additional information regarding the product and/or to purchase the product. For example, upon selecting a product within the shopping portion 416, the social networking system 202 can present additional product information associated with the product within a product page (e.g., a separate web page or window) associated with the product. In particular, FIG. 5 illustrates an example graphical user interface comprising a product page 502 associated with the product 414. As shown, the product page 502 may include product information 506 and a selectable option 508 for purchasing the product 414. The social networking system 202 can present the product page 502 as a new page or as an overlay to the merchant page 402, such as a lightbox window or pop-up window.

As shown, the product page 502 can include one or more images of the product 414 as well as textual information, such as a provider/manufacturer of the product 414, a name of the product 414, a price for the product 414, a description for the product 414, and/or an product identification number (or “Product ID”) for the product. In some embodiments, the product page 502 can also include additional or alternative content, such as comments, reviews, additional images, product information for related products, etc.

As shown and as mentioned above, the product page 502 can include selectable option 508 (e.g., the “Buy” button) for initiating a purchase of the product 414. Additionally or alternatively, the product page 502 can include a selectable “Add to Cart” option or other similar feature that allows a user to add the product 414 to a list or cart for later purchase. Upon selecting the selectable option 508, the social networking system 202 can initiate a purchasing process for the user to purchase the product 414. In some examples, the purchase of the product 414 can be initiated and executed by way of the social networking system 202 (e.g., the social networking system 202 can facilitate and manage the purchase). In additional or alternative embodiments, the social networking system 202 can redirect the user 406 to a third-party system or service (e.g., e.g., a third-party website associated with merchant 404) for finalizing the purchase of the product 414.

As mentioned above, in response to a request from the user 406 (e.g., in response to a selection of the “Shop All” link illustrated in FIG. 4), the social networking system 202 may present a storefront page associated with the merchant 404. For example, FIG. 6 illustrates an example storefront page 600 in accordance with the embodiments disclosed herein. The social networking system 202 can present the storefront page 600 as a new page or an overlay to the merchant page 400, such as in a lightbox or pop-up window.

As shown, the storefront page 600 includes product information for a number of products 602 associated with the merchant 404. Each of products 602 may be represented by a product item, such as product 604. As shown, the product item 604 includes an image, a name, and a price of the corresponding product. In addition, the product item 604 includes multiple selectable options 606 for the user to “See Details” for the product or “Buy” the product. In additional or alternative embodiments, the product item 604 can include any other content, information, and/or options suitable for a particular embodiment.

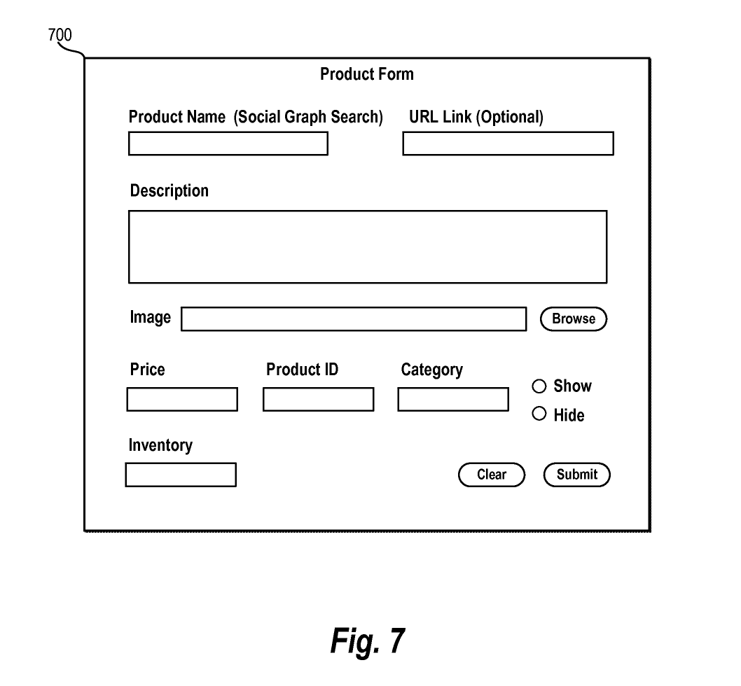

The products 602 presented in the storefront page 600 can include the products presented within the shopping portion 416, as described above in connection with FIG. 4. In addition, the products 602 may include additional products available from the merchant 404. For example, products 602 may include all products available from merchant 404, a larger selection of the products available from merchant 404, all products for which merchant 404 has inventory, and/or any other collection of products made available by merchant 404. In addition, as discussed above, the social networking system 202 may automatically identify and obtain product information for each of products 602 based on social networking communications by the merchant 404. Accordingly, the merchant 404 may not be required to manually add each of products 602 to the storefront page 600. Additionally or alternatively, the merchant 404 can add products in a more conventional manner, as will be described in more detail below with respect to FIG. 7.

Like the shopping portion 416, the social networking system 202 can customize the storefront page 600 for the user 406. For example, the social networking system 202 can customize the product page 602 to display the products 602 in an order that corresponds to product affinity scores for the products 602 (e.g., as calculated by customization manager 208). For example, products 602 storefront page 600 can be presented in an order that corresponds to a ranking of the products based on product affinity scores. Accordingly, products 602 that are most likely to be of interest to user 406 may be presented to user 406 first or at the top of the storefront page 600, while products 602 that are least likely to be of interest to user 406 may be presented last or at the bottom of the storefront page 600. Accordingly, no effort from the user 406 (e.g., scrolling through products 602) is necessary to view the products 602 that the user 406 is most likely to purchase.

In some embodiments, the storefront page 600 may not display all products available from the merchant 404. For example, the social networking system 202 can determine that a product does not have a product affinity score because the product is not relevant to the user 406, or that a product affinity score for the product is below a minimum threshold. As such, the social networking system 202 may omit such products from the storefront page 600 because the user 406 is likely not interested in these products.

As mentioned, the products 602 presented within the storefront page 600 may include products derived from product posts as well as products add to the storefront page 600 in other ways. For example, FIG. 7 shows an example product form graphical user interface 700 (or “GUI” 700) that a merchant (e.g., merchant 404) can use GUI 700 to add, modify, or remove a product. In particular, as shown in FIG. 7, GUI 700 can include options and/or fields to provide a “Product Name,” a “URL Link,” a “Description,” an “Image,” a “Price,” a “Product ID,” a “Category,” an “Inventory,” and/or any other information associated with a product to be added.

A merchant 404 can add a product using a variety of methods, as will be discussed below. For example, a merchant 404 can add a product manually. In particular, a merchant 404 can provide product information by providing a URL link to a web page including the product information. In additional or alternative embodiments, a merchant 404 can provide product information by providing a reference to a product node (e.g., within a social graph) where the product information for a product is stored. Further, a merchant 404 can add a product using a combination of the above methods.

As mentioned, in some embodiments, a merchant can manually enter information for a product into GUI 700 using the provided fields and options. For example, the merchant 404 can enter the product name, description, upload an image of the product, and enter a price for the product along with the product ID. The merchant 404 can also indicate whether to show or hide the product, as will be described below.

In additional or alternative embodiments, the social networking system 202 can obtain product information from a third-party resource. For example, the merchant 404 can input a URL (universal resource locator) into a corresponding field of GUI 700. The social networking system 202 can then identify (e.g., parse) product information found at a web page associated with the URL. For example, the social networking system 202 can identify (e.g., scrape) a product name, description, image, price, id, category, etc., from the web page associated with the URL. In some embodiments, upon obtaining the product information, the social networking system 202 can populate one or more text fields with the identified product information.

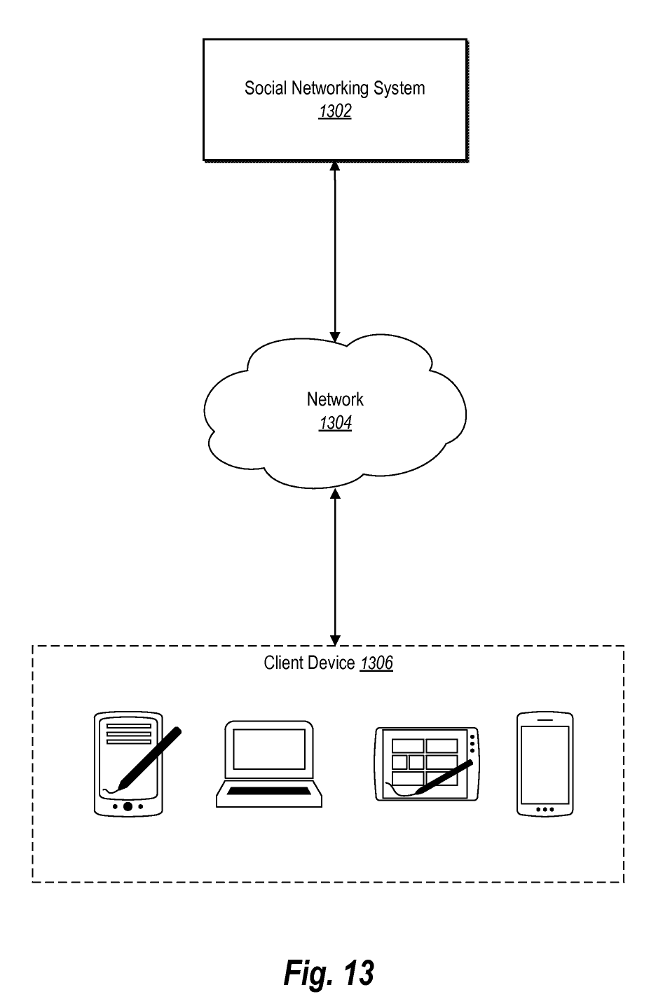

In a similar manner, the social networking system 202 can use a product ID to obtain additional product information. For example, a merchant 404 can enter a product ID. The social networking system 202 can use the provided product ID to identify product information for a product based on the product ID, for example, from a local or a third-party product database. In some embodiments, the social networking system 202 can obtain information from a social graph search based on merchant input. For example, the social networking system 202 can maintain a social graph that includes one or more product nodes. Each product node within the social graph can include product information associated with a corresponding product. Further detail regarding social networking systems, social graphs, and nodes is presented below with respect to FIG. 13.

In some embodiments, as a merchant inputs a product name in the corresponding “Product Name” field of GUI 700, the social networking system 202 can search the social graph for product nodes that match the merchant input. For example, if a merchant inputs the term “tent,” the social networking system 202 can display, in a drop-down list, a list of products that match the inputted term (e.g., a list of tents) and represent products nodes in the social graph. The merchant can then select a product from the displayed results. In some instances, each result displayed to the user is accompanied by an image of the product stored in a corresponding product node. Once the merchant selects a product, the social networking system 202 can populate one or more the text fields with product information from the product node corresponding to the selected product.

In addition, the social networking system 202 can modify product information based on interactions with GUI 700. For example, a merchant can use GUI 700 to add, remove, or change information associated with one or more products. For instance, a merchant can request to edit product information for a product, and in response, the social networking system 202 can provide the GUI 700 to the merchant populated with the corresponding product information. The merchant can make changes to the product information using the GUI 700, after which, the updated information can be stored.

As mentioned above, a merchant can choose whether to display a product by way of a merchant page and/or storefront page associated with the merchant. For example, the merchant can select either the “Show” or “Hide” button to show the product within or hide the product from a merchant page and/or a storefront page associated with the merchant. To illustrate, and with reference again to FIGS. 4 & 5, if the “Show” button is selected for product 414, the social networking system 202 can include the product 414 in the shopping portion 416 and/or storefront page 502. When the “Hide” button is selected, the social networking system 202 can prevent the product 414 from being included in the shopping portion 416 and/or storefront page 502 regardless of a product affinity score for the product 414. Alternatively, when the hide button is selected, the social networking system 202 can set the product affinity score for the product to zero (0) for all users.

In one or more embodiments, the social networking system 202 can create a product post when a product is added using the GUI 700. For example, after a merchant submits a product using the GUI 700, the social networking system 202 can create a product post using product information obtained through GUI 700. When multiple new products are added, the social networking system 202 can create a single product post advertising the group of newly added products. In addition, the social networking system 202 can make the newly added product available to be displayed in a shopping portion of a merchant page and/or on a storefront page.

Alternatively, when a product is adding using the GUI 700, the social networking system 202 can make a product available for display in a shopping portion of a merchant page and/or on a storefront page even when a product post is not created. For example, a merchant can add a large number of additional products using the GUI 700. For instance, the merchant may run a script that imports a number of products into the social networking system 202. The merchant may not want to create a product post for each newly added item, but may still desire to have the newly added products available for purchase by users. In this manner, the social networking system 202 can consider the newly added products when customizing the shopping portion of the merchant page and/or the storefront page even though the newly added products are not associated with a product post.

In some embodiments, the social networking system 202 can automatically generate and post a product post for products that do not have a product post, or that have not been highlighted (e.g., included in a product post) for a period of time. When a merchant adds multiple products, for example, using the GUI 700, the social networking system 202 can generate and post one product post each day, week, etc., until all of the products have been posted on the merchant page.

In one or more embodiments, the social networking system 202 can use aggregate product affinity scores to determine which product of the unposted products to post on the merchant page. For example, because product posts on the merchant page are the same for all users, the social networking system 202 can aggregate product affinity scores for each unposted product across a group of users to determine which product of the unposted products to post on the merchant page. For example, the social networking system 202 can determine that a majority of users are highly interested in a camping stove, which the merchant has previously added using GUI 700, but for which a product post has not been created. The social networking system 202 can generate and post a product post for the camping stove. In addition, the social networking system 202 can add marketing content to the product post that shares the popularity of the product among users.

In addition, in a similar manner, the social networking system 202 can re-post a product post for products that have previously been posted to the merchant page 402. For example, the social networking system 202 can automatically generate a product post for a product that only recently has become popular among users of the merchant page. Thus, even though a product has been posted previously, the social networking system 202 can re-post the product on the merchant page to highlight the product and/or add additional content information to the re-posted product post.

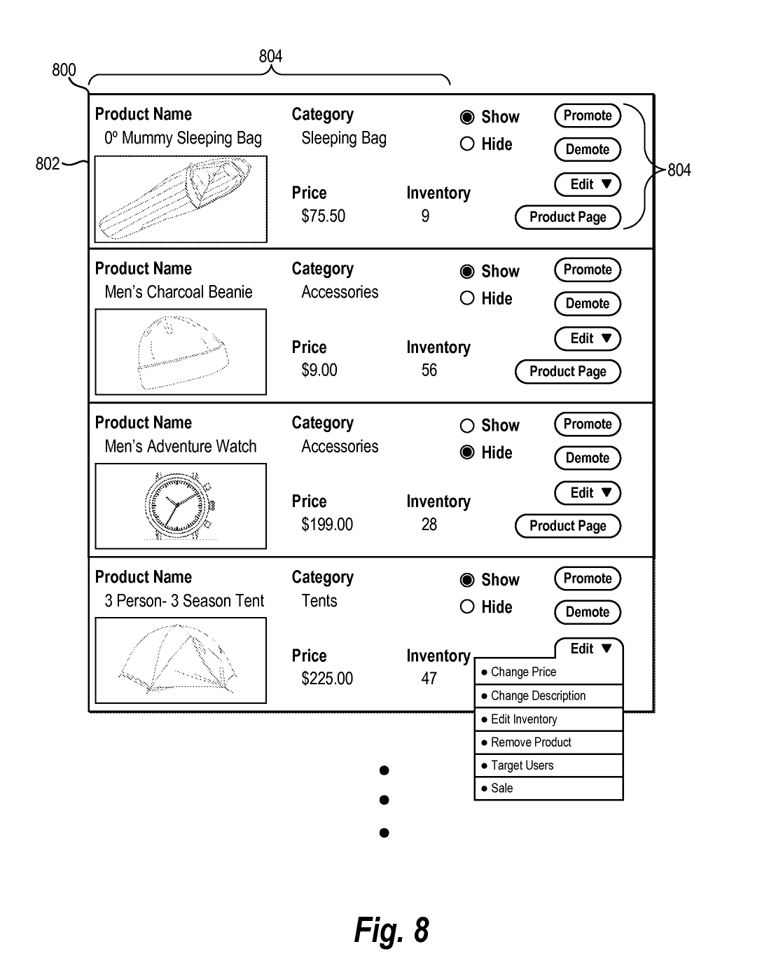

FIG. 8 illustrates a product listing graphical user interface 800 (or “GUI 800”) that includes a plurality of product listings, such as product listing 802. The GUI 800 can show all products that are associated with a merchant and/or a merchant page. Alternatively, in some embodiments, GUI 800 can be category-specific, only showing products within the same product category, such as the “Accessories” category

In one or more embodiments, each product listing can include product information, such as product information 804, associated with a corresponding product. For example, product information 804 includes an image of the product, a name of the product, a category for the product, a price of the product, an inventory amount for the product, etc. Further, product listing 802 may correspond to a product that the merchant has posted to the merchant's profile page. For example, each time a merchant posts a product in a product post, the social networking system 202 can identify product information for the product post 410, as described above, and can add a corresponding product listing to GUI 800. Thereafter the merchant can use GUI 800 to manage the products associated with the merchant page.

A merchant can use GUI 800 to perform any of a variety of management functions associated with the merchant's products. In particular, for each product listing, GUI 800 can include a plurality of selectable options 804, wherein each of the selectable options 804 allows the merchant to perform a corresponding action or actions with respect to the product listing. The selectable options 804 can include radio buttons, graphical buttons, control elements, drop-down menus, and/or any other types of selectable options. Each of selectable options 804 can have a corresponding function. For example, the selectable options 804 may include options that allow a merchant to hide or show a corresponding product listing, as discussed in more detail above.

In addition, the selectable options 804 can assist a merchant in editing product information for a product. For example, upon selecting the “Edit” button, a drop-down edit menu may appear. The drop-down edit menu can include operations such as changing the product price, description, and/or picture. The drop-down edit menu can also include an operation to edit the product inventory, target users, associate the product with a sale, and/or remote the product. For example, the merchant 404 can indicate that the Men's Charcoal Beanie is 15% off the next two weeks. In some instances, when a sale for an item is detected, the social networking system 202 may create a product post 410 on the merchant page 402 indicating the sale.

As another example, the selectable options 804 may include an option for a merchant to target a particular group or type of users (e.g., a particular demographic of users). In response to selecting the targeting option, the social networking system 202 may provide the merchant with additional interfaces that allow the merchant to specify information regarding the users the merchant would like to target for the corresponding product. Based on the targeting instructions, the social networking system 202 may adjust product affinity scores accordingly, such that the product is more likely to be presented to targeted users.

As further shown in the GUI 800, the selectable options can include a promote button and a demote button. The promote button and demote button can allow a merchant to provide an indication of the merchant's preference regarding each product with a single action (e.g., a mouse click). For example, the merchant can promote an item that the merchant desires to highlight more prominently. For instance, when a merchant selects the “Promote” button, the social networking system 202 may increase product affinity scores for the corresponding product. In contrast, when a merchant selects the “Demote” button, the social networking system 202 may decrease product affinity scores for the corresponding product.

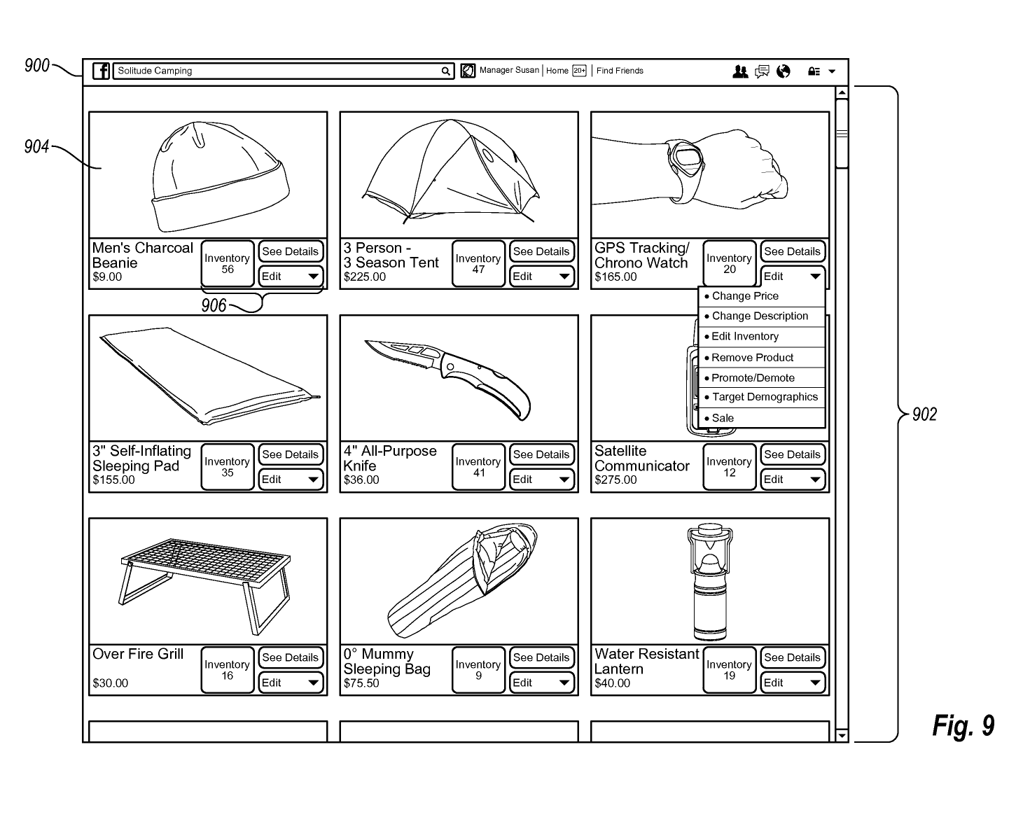

FIG. 9 illustrates another graphical user interface 900 (or “GUI 900”) for a merchant to manage one or more products associated with the merchant. In particular, GUI 900 may allow a user to manage one or more aspects of a storefront page associated with the merchant. As shown, the GUI 900 includes format similar to a merchant storefront page (e.g., storefront page 600 shown in FIG. 6) including a presentation of a number of products 902, wherein each product 902 is represented by a product item, such as product item 904.

GUI 900 can be customized for a merchant. For example, the products can be arranged in GUI 900 according to merchant preferences. Alternatively, the products 902 can be arranged based on product popularity, user interest, product recency, or product “age,” or based on any other factor.

In addition, for each of products 902, GUI 900 may include one or more options 906 for managing the corresponding product. In particular, the options 906 may include a “See Details” button that allows a merchant to access more detailed information for the product an “Edit” button that provides access to a drop-down menu of options for editing one or more options or pieces of information associated with the product, or any other suitable options.

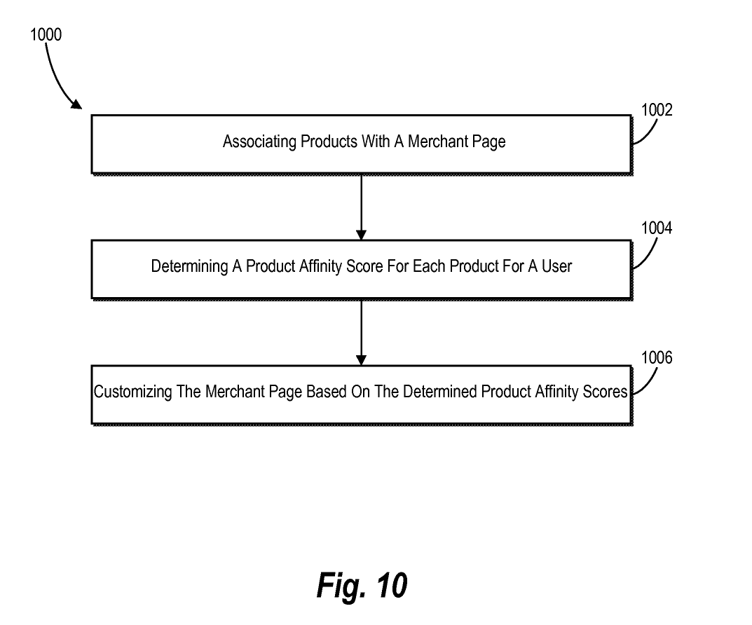

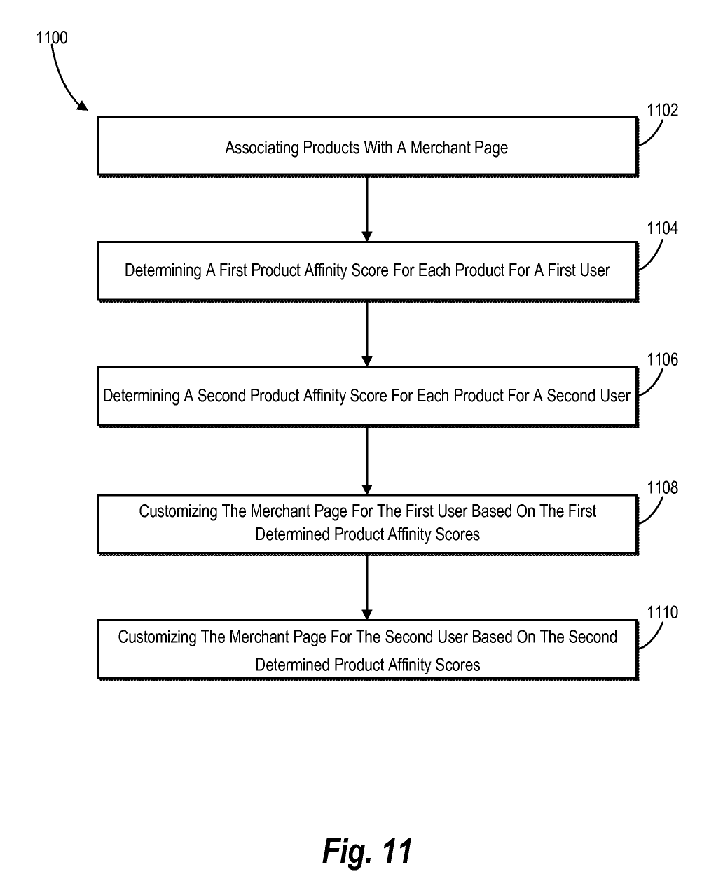

FIGS. 1-9, the corresponding text, and the examples, provide a number of different systems, devices, and graphical user interfaces for allowing a merchant to provide a customized product viewing experience to each user visiting a merchant page. In addition to the foregoing, embodiments disclosed herein also can be described in terms of flowcharts comprising acts and steps in a method for accomplishing a particular result. For example, FIGS. 10 and 11 illustrate flowcharts of exemplary methods in accordance with one or more embodiments disclosed herein. The methods described in relation to FIGS. 10 and 11 can be performed with less or more steps/acts or the steps/acts can be performed in differing orders. Additionally, the steps/acts described herein can be repeated or performed in parallel with one another or in parallel with different instances of the same or similar steps/acts.

FIG. 10 illustrates a flowchart of an example method 1000 for customizing a merchant page for a user. Method 1000 can be implemented by system 100 and/or social networking system 202. The method 1000 includes an act 1002 of associating products with a merchant page. In particular, act 1002 may include associating, based on a plurality of social networking communications by a merchant, a plurality of products with a merchant page. For example, act 1002 can include the product manager 204 of the social networking system 202 associating a product with a merchant page based on product information identified in a product post.

In addition, the method 1000 further includes an act 1004 of determining a product affinity score for each product for a user. In particular, act 1004 may include calculating, for a user, a product affinity score for each of a plurality of products. For example, the affinity score engine 206 of the social networking system 202 can determine a product affinity score for each product that is associated with a user, as described herein.

Further, the method 1000 includes an act 1006 of customizing the merchant page based on the determined product affinity scores. In particular, act 1006 may include customizing the merchant page to include a presentation of one or more of the plurality of products in accordance with the determined product affinity scores. For example, a customization manager 208 of the social networking system 202 can customize the merchant page for a user based on a set of product affinity score determined for the user in any suitable manner described herein. For instance, the customization manager 208 can customize a shopping portion of a merchant page based on product affinity scores determined for a user.

Referring now to FIG. 11, a flowchart of an example method 1100 for customizing a merchant page for a plurality of users. As shown, method 1100 can include an act 1102 of associating products 418 with a merchant page. In particular, act 1102 may include associating, based on a plurality of social networking communications by a merchant, a plurality of products with a merchant page. For example, act 1102 can include the product manager 204 of the social networking system 202 associating a product corresponding to a product included in a product post within a merchant page in any suitable manner disclosed herein.

In addition, the method 1100 further includes an act 1104 of determining a first product affinity score for each product for a first user. In particular, act 1104 may include calculating a first product affinity score for each of a plurality of products for a first user. For example, an affinity score engine 206 of the social networking system 202 can determine a first product affinity score for each product that is associated with a first user, as described herein.

Further, the method 1100 further includes an act 1106 of determining a second product affinity score for each product for a second user. In particular, act 1106 includes determining a second product affinity score for each of the plurality of products for a second user. For example, the affinity score engine 206 of the social networking system 202 can determine a second product affinity score for each product that is associated with a second user, as described herein.

In addition, the method 1100 includes an act 1108 of customizing the merchant page for the first user based on the first determined product affinity scores. In particular, act 1108 may include customizing the merchant page for the first user to include a presentation of one or more of the plurality of products in accordance with the determined first product affinity scores to present to the first user. For example, the customization manager 208 of the social networking system 202 can customize the merchant page for a first user based on a set of product affinity score determined for the first user in any suitable manner described herein. For instance, the customization manager 208 can customize a shopping portion of a merchant page based on product affinity scores determined for the first user.

Further, the method 1100 includes an act 1110 of customizing the merchant page for the second user based on the second determined product affinity scores. In particular, act 1110 may include customizing the merchant page for the second user to include a presentation of one or more of the plurality of products in accordance with the determined second product affinity scores to present to the second user. For example, the customization manager 208 of the social networking system 202 can customize the merchant page for a second user based on a set of product affinity score determined for the second user in any suitable manner described herein. For instance, the customization manager 208 can customize a shopping portion of a merchant page based on product affinity scores determined for the second user.

FIG. 12 illustrates, in block diagram form, an exemplary computing device 1200 that may be configured to perform one or more of the processes described above. One will appreciate that social networking system 102, merchant computing device 104, computing devices 106, and social networking system 20 each may comprise one or more computing devices in accordance with the example computing device 1200 shown in FIG. 12. The computing device 1200 can comprise a processor 1202, a memory 1204, a storage device 1206, an I/O interface 1208, and a communication interface 1210, which can be communicatively coupled by way of communication infrastructure 1212. While an exemplary computing device 1200 is shown in FIG. 12, the components illustrated in FIG. 12 are not intended to be limiting. Additional or alternative components can be used in other embodiments. Furthermore, in certain embodiments, a computing device 1200 can include fewer components than those shown in FIG. 12. Components of computing device 1200 shown in FIG. 12 will now be described in additional detail.

In particular embodiments, processor 1202 includes hardware for executing instructions, such as those making up a computer program. As an example and not by way of limitation, to execute instructions, processor 1202 can retrieve (or fetch) the instructions from an internal register, an internal cache, memory 1204, or storage device 1206 and decode and execute them. In particular embodiments, processor 1202 can include one or more internal caches for data, instructions, or addresses. As an example and not by way of limitation, processor 1202 can include one or more instruction caches, one or more data caches, and one or more translation lookaside buffers (TLBs). Instructions in the instruction caches can be copies of instructions in memory 1204 or storage 1206.

Memory 1204 can be used for storing data, metadata, and programs for execution by the processor(s). Memory 1204 can include one or more of volatile and non-volatile memories, such as Random Access Memory (“RAM”), Read Only Memory (“ROM”), a solid state disk (“SSD”), Flash, Phase Change Memory (“PCM”), or other types of data storage. Memory 1204 can be internal or distributed memory.

Storage device 1206 includes storage for storing data or instructions. As an example and not by way of limitation, storage device 1206 can comprise a non-transitory storage medium described above. Storage device 1206 can include a hard disk drive (HDD), a floppy disk drive, flash memory, an optical disc, a magneto-optical disc, magnetic tape, or a Universal Serial Bus (USB) drive or a combination of two or more of these. Storage device 1206 can include removable or non-removable (or fixed) media, where appropriate. Storage device 1206 can be internal or external to the computing device 1200. In particular embodiments, storage device 1206 is non-volatile, solid-state memory. In other embodiments, Storage device 1206 includes read-only memory (ROM). Where appropriate, this ROM can be mask programmed ROM, programmable ROM (PROM), erasable PROM (EPROM), electrically erasable PROM (EEPROM), electrically alterable ROM (EAROM), or flash memory or a combination of two or more of these.

I/O interface 1208 allows a user to provide input to, receive output from, and otherwise transfer data to and receive data from computing device 1200. I/O interface 1208 can include a mouse, a keypad or a keyboard, a touch screen, a camera, an optical scanner, network interface, modem, other known I/O devices or a combination of such I/O interfaces. I/O interface 1208 can include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interface 1208 is configured to provide graphical data to a display for presentation to a user. The graphical data can be representative of one or more graphical user interfaces and/or any other graphical content as can serve a particular implementation.

Communication interface 1210 can include hardware, software, or both. In any event, communication interface 1210 can provide one or more interfaces for communication (such as, for example, packet-based communication) between computing device 1200 and one or more other computing devices or networks. As an example and not by way of limitation, communication interface 1210 can include a network interface controller (NIC) or network adapter for communicating with an Ethernet or other wire-based network or a wireless NIC (WNIC) or wireless adapter for communicating with a wireless network, such as a WI-FI.

Additionally or alternatively, communication interface 1210 can facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks can be wired or wireless. As an example, communication interface 1210 can facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Communication infrastructure 1212 can include hardware, software, or both that couples components of computing device 1200 to each other. As an example and not by way of limitation, communication infrastructure 1212 can include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

As mentioned above, one or more features disclosed herein may be implemented within a social networking system. A social networking system can enable its users (such as persons or organizations) to interact with the system and with each other. The social networking system can, with input from a user, create and store in the social networking system a user profile associated with the user. The user profile can include demographic information, communication-channel information, and information on personal interests of the user. The social networking system can also, with input from a user, create and store a record of relationships of the user with other users of the social networking system, as well as provide services (e.g. wall posts, photo-sharing, event organization, messaging, games, or advertisements) to facilitate social interaction between or among users.

With so much data related to so many users and products, the social networking system may combine, organize, or correlate data intelligently so that the data may be used in a customized manner to benefit the users of the social networking system. As a result, the social networking system can quickly identify a subset of the data that is relevant to a particular user and/or product. The social networking system may store records of users, products, and relationships between users and/or products in a social graph comprising a plurality of nodes and a plurality of edges connecting the nodes.

Nodes may comprise a plurality of user nodes. A user node of the social graph may correspond to and include data associated with a user of the social-networking social networking system. As described above, a user may be an individual (human user), an entity (e.g., an enterprise, business, or third-party application), or a group (e.g., of individuals or entities). A user node corresponding to a user may comprise information provided by the user and information gathered by various systems, including the social-networking social networking system. For example, the user may provide his or her name, profile picture, city of residence, contact information, birth date, gender, marital status, family status, employment, educational background, preferences, interests, and other demographic information to be included in the user node. Each user node of the social graph may correspond to a web page (typically known as a “profile page”) associated with the corresponding user. For example, the social-networking social networking system 104 can access a user node corresponding to the user and construct a profile page including the user's name, a profile picture, and other information associated with the user. A profile page may include all or a portion of the information stored within a user's node based on one or more privacy settings or other configurable settings.

Nodes may also include a plurality of product nodes. Each product node may correspond to a particular product or a group of products. A product node can include any suitable information associated with a product. For example, a product node can include a name of a product, a description of the product, an identification of one or more merchants that provide the product, specifications for the product, price information for the product, images of the product, videos of the product, an identification of users that own or use the product, an identification of users that want the product, an identification of users that “like” the product, an identification of users that have otherwise expressed interest in or interacted with the product, a URL address for a website associated with the product, a product category associated with the product, an identification of one or more related products, one or more recommendations or reviews of the product, one or more ratings of the product, options (e.g., size options, color options, shipping options, purchase options) for the product, a manufacturer of the product, or any other information associated with the product. Similar to user nodes, each product node of the social graph may correspond to a web page or “profile page” where users can access the corresponding product information. For example, the social networking system can access a product node corresponding to a product, and construct a profile page (e.g., viewable by way of a browser or mobile application) including product information from the product node.

In some embodiments, a user may reference a particular user node or product node within a social networking communication. For example, a user can include a “tag” to a node within a social networking post or comment. The tag may serve as or include a link to a profile page for the tagged node. To illustrate, a tag for a product node representing a particular product may serve as a link to a profile page for the product. Accordingly, once a user has inserted a tag in a post or other communication, the user or other users can use (e.g., select) the tag to access the profile page for the tagged product. In some embodiments, the tag can include text, such as the name of the tagged product. Additionally or alternatively, the text of the tag can be visually distinguishable from other text in the communication. For example, the text of the tag can be bolded, underlined, italicized, in all caps, a different color than the other text, a different size than the other text, a different font type than the other text, and/or visually distinguishable in some other manner. Furthermore, the tag can include any other content (e.g., an image or an icon) associated with the tagged node.

In some embodiments, the social networking system can assist a user to include a tag in a communication. For example, the social networking system may detect that a user is typing a string of characters into a communication, search the node data for one or more nodes matching the string of characters (e.g., nodes with associated names matching the string of characters), and present one or more matching nodes to the user. In particular, the social networking system can present a list of matching nodes (e.g., within a drop-down list or window) below or nearby the typed string of characters. Furthermore, the social networking system can update the search for nodes and the list of matching nodes as the user continues to type. At any point, the user can select one of the listed nodes to include a tag for the node in the communication.

To illustrate, as a user begins typing the name of a product in a communication, the social networking system can search for products (e.g., products represented by product nodes in the social graph) having a name that matches the name or portion of name typed by the user, and provide a list of the matching products to the user. The user can then select the intended product from the list of matching products. The social networking system can insert a tag representing the product into the communication in response to the detected selection. Thereafter, users may select or otherwise interact with the tag to access a profile page for the tagged product. Additionally or alternatively, the social networking system can associate the communication and/or any related activities (e.g., likes, comments, replies) to the product node representing the product. In particular, the social networking system can associate user nodes with the product node (e.g., by way of one or more edges connecting the user nodes and the product node) based on the activities of the users with respect to the communication including the tag.

An edge between a pair of nodes may represent a relationship between the pair of nodes. For example, an edge between two user nodes can represent a friendship between the two users. As another example, an edge between a user node and a product node can represent a relationship between a user and a product (e.g., that the user likes, uses, or owns the product) or an interaction between the user and the product (e.g., that the user mentioned the product, shopped for the product, viewed a profile page for the product, etc.). As a further example, an edge between two product nodes can represent a relationship between two products (e.g., that the products are in a common product category, that the products are often purchased together, that users interested in one product are often interested in the other product, that the products share one or more common attributes, etc.). Furthermore, an edge between a product node and a product group node (e.g., a product node for a group or category of products as opposed to a single product) may represent that the product belongs to the product group.

Edges between user nodes and product nodes may be based on social networking activity data obtained by the social networking system. In particular, if a piece of social networking activity data obtained by the social networking system indicates an interaction between a user and a product, the social networking system may create an edge between a user node associated with the user and a product node associated with the product to represent that social networking activity of the user. In particular, the social networking system may generate an edge between a user node and a product node to represent any social networking activity related to a particular product or product category, examples of which are discussed herein in more detail.

The degree of separation between any two nodes is defined as the minimum number of “hops” required to traverse the social graph from one node to the other. A degree of separation between two nodes can be considered a measure of relatedness between the users or the products represented by the two nodes in the social graph. For example, two users having user nodes that are directly connected by an edge (i.e., are first-degree nodes) may be described as “connected users” or “friends.” Similarly, two users having user nodes that are connected only through another user node (i.e., are second-degree nodes) may be referred to as “friends of friends.” Degrees of separation apply equally to relationships between user nodes and product nodes. For example, a user node being connected to a product node by a single degree of separation may indicate a closer relationship or greater product interest than a connection by multiple degrees of separation. The more degrees of separation between a user node and a product node may indicate a lower likelihood of interest by the user in the corresponding product.

Furthermore, a connection between a user node and a product node by way of another user node may indicate a likelihood of interest in the product because the user is connected to another user that is connected to the product in some way. To illustrate, a user interested in purchasing a new smartphone may be interested to learn what smartphones are used by the user's friends or friends of friends. Accordingly, connections between a user node and a product node by way of one or more other user nodes may be particularly helpful to a user researching product information.

A social networking system can support a variety of applications, such as photo sharing, on-line calendars, and events, gaming, instant messaging, and advertising. For example, the social networking system can also include media sharing capabilities. Also, the social networking system can allow users to post photographs and other multimedia files to a user's profile page (typically known as “wall posts” or “timeline posts”) or in a photo album, both of which can be accessible to other users of the social networking system depending upon the user's configured privacy settings. The social networking system can also allow users to configure events. For example, a first user can configure an event with attributes including time and date of the event, location of the event and other users invited to the event. The invited users can receive invitations to the event and respond (such as by accepting the invitation or declining it). Furthermore, the social networking system can allow users to maintain a personal calendar. Similarly to events, the calendar entries can include times, dates, locations, and identities of other users.

FIG. 13 illustrates an example network environment of a social networking system. In particular embodiments, a social networking system 1302 can comprise one or more data stores. In particular embodiments, the social networking system 1302 can store a social graph comprising user nodes, concept nodes, and edges between nodes as described earlier. Each user node can comprise one or more data objects corresponding to information associated with or describing a user. Each concept node can comprise one or more data objects corresponding to information associated with a concept. Each edge between a pair of nodes can comprise one or more data objects corresponding to information associated with a relationship between users (or between a user and a concept, or between concepts) corresponding to the pair of nodes.

In particular embodiments, the social networking system 1302 can comprise one or more computing devices (e.g., servers) hosting functionality directed to operation of the social networking system 1302. A user of the social networking system 1302 can access the social networking system 1302 using a client device such as client device 1306. In particular embodiments, the client device 1306 can interact with the social networking system 1302 through a network 1304.

The client device 1306 can be a desktop computer, a laptop computer, a tablet computer, a personal digital assistant (PDA), an in- or out-of-car navigation system, a smart phone or other cellular or mobile phone, or a mobile gaming device, other mobile device, or other suitable computing devices. Client device 1306 can execute one or more client applications, such as a web browser (e.g., Microsoft Windows Internet Explorer, Mozilla Firefox, Apple Safari, Google Chrome, Opera, etc.) or a native or special-purpose client application (e.g., Facebook for iPhone or iPad, Facebook for Android, etc.), to access and view content over network 1304.

Network 1304 can represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which client devices 1306 can access the social networking system 1302.

While these methods, systems, and user interfaces utilize both publicly available information as well as information provided by users of the social networking system, all use of such information is to be explicitly subject to all privacy settings of the involved users and the privacy policy of the social networking system as a whole.

In the foregoing specification, one or more embodiments have been described with reference to specific exemplary embodiments thereof. Various embodiments and aspects thereof are described with reference to details discussed herein, and the accompanying drawings illustrate the various embodiments. The description above and drawings are for illustrative purposes and are not to be construed as limiting. Numerous specific details are described to provide a thorough understanding of various embodiments disclosed herein.

The methods and systems described herein can be embodied in other specific forms without departing from their spirit or essential characteristics. The described embodiments are to be considered in all respects only as illustrative and not restrictive. For example, the methods described herein can be performed with less or more steps/acts or the steps/acts can be performed in differing orders. Additionally, the steps/acts described herein can be repeated or performed in parallel with one another or in parallel with different instances of the same or similar steps/acts. The scope of the embodiments disclosed herein is, therefore, indicated by the appended claims rather than by the foregoing description. All changes that come within the meaning and range of equivalency of the claims are to be embraced within their scope.

What is claimed is:

1. A method comprising:
associating, based on a plurality of social networking communications by a merchant, a plurality of products with a merchant page;
determining, using at least one processor, a product affinity score for each product of the plurality of products for a user; and
customizing the merchant page to include a presentation of one or more products of the plurality of products in accordance with the determined product affinity scores.

2. The method of claim 1, further comprising detecting a user request to access the merchant page, and wherein determining the product affinity scores and customizing the merchant page occurs in response to the user request.

3. The method of claim 1, wherein the product affinity score is based on one or more product affinity factors.

4. The method of claim 3, wherein the product affinity factors include one or more of a user profile factors, user activity factors, social trend factors, or merchant preference factors.

5. The method of claim 4, wherein the merchant preference factors include a merchant promotion factor for one or more products of the plurality of products.

6. The method of claim 1, wherein customizing the merchant page further comprises ranking the plurality of products according to corresponding product affinity scores.

7. The method of claim 6, further comprising selecting the one or more products based on the ranking.

8. The method of claim 1, further comprising receiving a selection of a product within the presentation of the one or more products.

9. The method of claim 8, further comprising presenting a product page associated with the selected product.

10. The method of claim 9, further comprising:
receiving an request from the user on the product page to purchase the product; and
initiating the purchase of the product.

11. The method of claim 1, further comprising receiving a request to access a storefront page associated with the merchant.

12. The method of claim 11, further comprising presenting the storefront page to the user, wherein the storefront page includes the one or more products and one or more additional products associated from the plurality of products.

13. The method of claim 12, further comprising customizing the storefront page in accordance with the determined product affinity scores.

14. The method of claim 1, further comprising displaying the one or more products within a shopping portion of the merchant page.

15. The method of claim 14, wherein customizing the merchant page comprises customizing the shopping portion of the merchant page to display the presentation of the one or more of products in accordance with the determined product affinity scores.

16. The method of claim 15, further comprising presenting the shopping portion with one or more of the plurality of social networking communications by the merchant.

17. The method of claim 1, wherein each product of the plurality of products in the presentation of products corresponds to a different product category.

18. A method comprising:
associating, based on a plurality of social networking communications by a merchant, a plurality of products with a merchant page;
determining, using at least one processor, a first product affinity score for each product of the plurality of products for a first user;
determining, using the at least one processor, a second product affinity score for each product of the plurality of products for a second user;
customizing the merchant page for the first user to include a presentation of a first set of one or more products of the plurality of products in accordance with the determined first product affinity scores; and
customizing the merchant page for the second user to include a presentation of a second set of one or more products of the plurality of products in accordance with the determined second product affinity scores.

19. The method of claim 18, wherein customizing the merchant page for the first user further comprises customizing a shopping portion of the merchant page to display the first set of one or more of products in accordance with the determined first product affinity scores.

20. A system comprising:
one or more server devices storing instructions thereon that, when executed by at least one processor, cause the system to:
associate, based on a plurality of social networking communications by a merchant, a plurality of products for a merchant page;
determine, using at least one processor, a product affinity score for each product of the plurality of products for a user; and
customize the merchant page to include a presentation of one or more products of the plurality of products in accordance with the determined product affinity scores.
